(19) United States
(12) Patent Application Publication
(10) Pub. No.: US 2025/0196327 A1
(43) Pub. Date: Jun. 19, 2025

(54) BODY STRUCTURE FOR A ROBOT

(71) Applicant: Boston Dynamics, Inc, Waltham, MA (US)

(72) Inventor: Joshua Timothy Geating, Allston, MA (US)

(21) Appl. No.: 18/541,213

(22) Filed: Dec. 15, 2023

(51) Int. Cl. B25J 9/12; B25J 17/00

(52) U.S. Cl. CPC B25J 9/126; B25J 17/00

(57) ABSTRACT

The invention includes systems and methods for relating to improved body structures for robots. A robot assembly includes a base member (e.g., a pelvis base). The robot assembly includes a first hip member rotatably connected to the pelvis base. The first hip member is connected to a first electric actuator configured to rotate the first hip member about a first hip axis relative to the pelvis base. A first intermediate member is rotatably connected to the first hip member. The first intermediate member is connected to a second electric actuator configured to rotate the first intermediate member about a second hip axis relative to the first hip member. A first leg member is rotatably connected to the first intermediate member. The first leg member is connected to a third electric actuator configured to rotate the first leg member about a third hip axis relative to the first intermediate member.

### TECHNICAL FIELD

This disclosure relates generally to robotics and more specifically to systems, methods and apparatuses relating to the body structure and movement capabilities of robots.

### BACKGROUND

Robots may include one or more rigid members that are rotatably coupled to one or more other rigid members. Various types of robotic devices are capable of performing a variety of functions. Robotic devices may be used for applications involving material handling, transportation, welding, assembly, and dispensing, among other areas. As robotic systems become increasingly prevalent in numerous aspects of modern life, the desire for practical and efficient robotic systems increases.

### SUMMARY

In legged robots (e.g., biped and/or humanoid robots), the middle body region (e.g., the pelvis and/or surrounding areas) can be particularly space-constrained. Within a relatively small volume, it is desirable for the pelvis to include hardware enabling three rotational degrees of freedom per hip, with the corresponding actuation axes intersecting or nearly intersecting each other. In practice, these constraints create several challenges. First, the range of motion for the hip joints is often very low (e.g., by comparison to a human being). Second, structures that connect the actuators are often highly cantilevered, making them less stiff and/or strong than would be desirable (as well as possibly heavier and/or harder to manufacture). Third, the volume required to stack actuators (e.g., in front of each other and/or on top of each other) can make the actuator dimension in the direction of stacking very large, which can also be undesirable.

One exemplary prior pelvis configuration is shown and described in U.S. Pat. No. 9,555,846. In this configuration, a pelvis utilizing an “X-Z-Y” joint order is shown (where X denotes an abduction/adduction axis, Y denotes a flexion/extension axis, and Z denotes a pronation/supination axis). For example, a first actuator can rotate first and second robotic components (e.g., a pelvis and a first hip) relative to each other along a first hip-x axis; a second actuator can rotate second and third robotic components (e.g., the first hip and a first intermediate extension) relative to each other along a first hip-z axis; and a third actuator can rotate third and fourth robotic components (e.g., the first intermediate extension and a first leg member) relative to each other along a first hip-y axis. A second chain of rotatable robotic components (e.g., a second hip, a second intermediate extension, and a second leg member) can stem from the pelvis in a similar fashion. Other prior pelvis configurations also exist.

The present invention includes systems, methods and apparatuses for robots having improved body (e.g., pelvis and/or middle-body) configurations. In some embodiments, the invention includes a first actuator for rotating a first hip of the robot, relative to a base member (e.g., a pelvis base) of the robot, along a first axis (e.g., a flexion/extension or hip-y axis). In some embodiments, a second actuator is included for rotating the first hip relative to a first intermediate member along a second axis (e.g., an abduction/adduction or hip-x axis). In some embodiments, a third actuator is included for rotating the first intermediate member with respect to a first leg along a third axis (e.g., a pronation/supination or hip-z axis). In some embodiments, the X and Z axes are reversed in order (i.e., the joint order may be Y-Z-X instead of Y-X-Z). In some embodiments, the X, Y and Z axes are mutually orthogonal. In some embodiments, the X, Y and Z axes are substantially mutually orthogonal (e.g., they extend in directions that may be decomposed into components axes that are mutually orthogonal and/or enable a range of motion spanning such mutually orthogonal directions). In some embodiments, “substantially mutually orthogonal” may include deviations of up to 45 degrees from true orthogonality for each axis with respect to each other axis. For example, the hip-y axis may be positioned at a 95-135 degree angle with respect to the hip x and/or hip-z axes. In some embodiments, the X, Y and Z axes do not intersect but are displaced from each other by a small amount (e.g., 1-5%) of a height of the robot.

In one aspect, the invention features a robot assembly. The robot assembly includes a base member (e.g., a pelvis base). The robot assembly includes a first hip member rotatably connected to the base member. The first hip member is rotatable about a first hip axis. The robot assembly includes a first intermediate member rotatably connected to the first hip member. The first intermediate member is rotatable about a second hip axis. The robot assembly includes a first leg member rotatably connected to the first intermediate member. The first leg member is rotatable about a third hip axis.

In some embodiments, the first hip axis is a first flexion/extension axis. In some embodiments, the second hip axis is a first abduction/adduction axis and the third hip axis is a first pronation/supination axis. In some embodiments, the second hip axis is a first pronation/supination axis and the third hip axis is a first abduction/adduction axis. In some embodiments, the first hip axis is a first hip-y axis, the second hip axis is a first hip-x axis, and the third hip axis is a first hip-z axis. In some embodiments, the first hip axis is a first hip-y axis, the second hip axis is a first hip-z axis, and the third hip axis is a first hip-x axis.

In some embodiments, the robot assembly includes a second hip member rotatably connected to the base member. The second hip member is rotatable about a fourth hip axis. In some embodiments, the robot assembly includes a second intermediate member rotatably connected to the second hip member. The second intermediate member is rotatable about a fifth axis. In some embodiments, the robot assembly includes a second leg member rotatably connected to the second intermediate member. The second leg member is rotatable about a sixth axis.

In some embodiments, the fourth hip axis is a second flexion/extension axis. In some embodiments, the fifth hip axis is a second abduction/adduction axis and the sixth hip axis is a second pronation/supination axis. In some embodiments, the fifth hip axis is a second pronation/supination axis and the sixth hip axis is a second abduction/adduction axis. In some embodiments, the fourth hip axis is a second hip-y axis, the fifth hip axis is a second hip-x axis, and the sixth hip axis is a second hip-z axis. In some embodiments, the fourth hip axis is a second hip-y axis, the fifth hip axis is a second hip-z axis, and the sixth hip axis is a second hip-x axis.

In some embodiments, the first hip axis intersects, or is displaced by not more than a threshold distance from, the second hip axis, wherein the threshold distance is 5% of a height of a robot that includes the robot assembly. In some embodiments, the second hip axis intersects, or is displaced by not more than a threshold distance from, the third hip axis, wherein the threshold distance is 5% of a height of a robot that includes the robot assembly.

In some embodiments, the base member is rotatably connected to a back member. In some embodiments, the first hip member is rotatable about the first axis (e.g., continuously, at least 180 degrees, at least 360 degrees, or at least 720 degrees). In some embodiments, the first leg member is rotatable about the third axis (e.g., continuously, at least 180 degrees, at least 360 degrees, or at least 720 degrees). In some embodiments, the second hip member is rotatable about the fourth axis (e.g., continuously, at least 180 degrees, at least 360 degrees, or at least 720 degrees). In some embodiments, the second leg member is rotatable about the sixth axis (e.g., continuously, at least 180 degrees, at least 360 degrees, or at least 720 degrees).

In some embodiments, the first hip member is connected to a first electric actuator configured to rotate the first hip member relative to the base member. In some embodiments, the first intermediate member is connected to a second electric actuator configured to rotate the first intermediate member relative to the first hip member. In some embodiments, the first leg member is connected to a third electric actuator configured to rotate the first leg member relative to the first intermediate member. In some embodiments, the second hip member is connected to a fourth electric actuator configured to rotate the second hip member relative to the base member. In some embodiments, the second intermediate member is connected to a fifth electric actuator configured to rotate the second intermediate member relative to the second hip member. In some embodiments, the second leg member is connected to a sixth electric actuator configured to rotate the second leg member relative to the second intermediate member.

In some embodiments, the first electric actuator has a diameter to length ratio of at least 1:1 (or, optionally, 0.8, 1.25, 1.5, 2.0, or another number). In some embodiments, first electric actuator is configured to rotate continuously. In some embodiments, the second electric actuator has a diameter to length ratio of at most 1:1 (or, optionally, 1.25, 0.8, 0.5, or another number). In some embodiments, the third electric actuator has a diameter to length ratio of at least 1:1 (or, optionally, 0.8, 1.25, 1.5, 2.0, or another number). In some embodiments, the third electric actuator is configured to rotate continuously.

In some embodiments, the first hip member is canted at least 5 degrees relative to a vertical axis of the base member (e.g., 10 degrees, 15 degrees, 20 degrees, or another number). In some embodiments, such a configuration provides additional adduction range-of-motion compared to non-canted morphologies. In some embodiments, the first axis and the fourth axis form an angle of less than 180 degrees (e.g., 170 degrees, 160 degrees, 150 degrees, 140 degrees, or another angle). In some embodiments, the second axis and the fifth axis are parallel when the first and fourth members are in a ground state configuration. In some embodiments, the third axis and the sixth axis are parallel when the first and fourth members are in a ground state configuration.

In some embodiments, one or more of the members comprise a double yoke (e.g., the hip-x actuator to the hip-y actuator, as shown below, or the hip-x actuator to the hip-z actuator). In some embodiments, each yoke connects directly to the first, the second, and/or the third electric actuator. In some embodiments, the robot assembly includes a first back member positioned above the base member. In some embodiments, the first back member is connected to a first back actuator positioned above the base member. In some embodiments, such a configuration frees up space in torso and/or permits the pelvis member to have a compact geometry. In some embodiments, the first back member is connected to at least one additional linear actuator in a back of the robot, the linear actuator coupled above the base member. In some embodiments, such a configuration can preserve space in the torso, compared to, for example, rotary actuators. In some embodiments, the robot assembly includes a first back actuator located above the base member, the first back actuator configured to rotate the back member, relative to the base member, about a back pronation/supination axis. In some embodiments, the robot assembly includes a second back actuator and a third back actuator, the second and third back actuators configured to rotate the back member, relative to the base member, about a back abduction/adduction axis and a back flexion/extension axis.

In another aspect, the invention features a method of causing movement of a robot assembly. The method comprises providing a robot assembly including a base member, a first hip member rotatably connected to the base member and rotatable about a first axis, a first intermediate member rotatably connected to the first hip member and rotatable about a second axis, and a first leg member rotatably connected to the first intermediate member and rotatable about a third axis. The method includes operating a first actuator interfacing with the base member to cause relative rotation of the base member and the first hip member. The method includes operating a second actuator interfacing with the first intermediate member to cause relative rotation between the first hip member and the first intermediate member. The method includes operating a third actuator interfacing with the first leg member to cause relative rotation between the first intermediate member and the first leg member.

In some embodiments, a continuous (e.g., 360-degree and/or limitless) range of motion is possible for the first (e.g., hip-Y) and/or third (e.g., hip-X and/or hip-Z) actuators. In some embodiments, a significant (e.g., 25-60 degree adduction or 50-120 degree abduction degree) range of motion is possible for the second actuator. In some embodiments, the invention allows for less cantilevered structures than prior designs (e.g., because they do not need to “reach around” each other to maintain intersecting or near-intersecting axes). In some embodiments, the invention does not utilize actuators stacked in front of each other in a direction extending in front of the robot. In some embodiments, actuators are stacked along a dimension that tolerates larger variation in size (e.g., a y-axis in biped and/or humanoid robots). In some embodiments, a dimension of the robot (e.g., an x-axis in biped and/or humanoid robots) is decreased relative to conventional configurations, which can provide advantages in aesthetics, industrial design, range of motion, total workspace volume, and the ability to navigate tight spaces.

### BRIEF DESCRIPTION OF DRAWINGS

The advantages of the invention, together with further advantages, may be better understood by referring to the following description taken in conjunction with the accompanying drawings. The drawings are not necessarily to scale, and emphasis is instead generally placed upon illustrating the principles of the invention.

FIG. 1 illustrates an example configuration of a robotic device, according to an illustrative embodiment of the invention.

FIG. 2 illustrates an example of a humanoid robot, according to an illustrative embodiment of the invention.

FIGS. 3A-3G illustrate example views of a humanoid robot in different poses, according to an illustrative embodiment of the invention.

FIG. 4 illustrates an example cross-sectional view of a middle body region of a humanoid robot, according to an illustrative embodiment of the invention.

FIG. 5 illustrates a flowchart of an exemplary computer-implemented method, according to an illustrative embodiment of the invention.

### DETAILED DESCRIPTION

An example implementation involves a robotic device configured with at least one robotic limb, one or more sensors, and a processing system. The robotic limb may be an articulated robotic appendage including a number of members connected by joints. The robotic limb may also include a number of actuators (e.g., 2-5 actuators) coupled to the members of the limb that facilitate movement of the robotic limb through a range of motion limited by the joints connecting the members. The sensors may be configured to measure properties of the robotic device, such as angles of the joints, pressures within the actuators, joint torques, and/or positions, velocities, and/or accelerations of members of the robotic limb(s) at a given point in time. The sensors may also be configured to measure an orientation (e.g., a body orientation measurement) of the body of the robotic device (which may also be referred to herein as the “base” of the robotic device). Other example properties include the masses of various components of the robotic device, among other properties. The processing system of the robotic device may determine the angles of the joints of the robotic limb, either directly from angle sensor information or indirectly from other sensor information from which the joint angles can be calculated. The processing system may then estimate an orientation of the robotic device based on the sensed orientation of the base of the robotic device and the joint angles.

An orientation may herein refer to an angular position of an object. In some instances, an orientation may refer to an amount of rotation (e.g., in degrees or radians) about three axes. In some cases, an orientation of a robotic device may refer to the orientation of the robotic device with respect to a particular reference frame, such as the ground or a surface on which it stands. An orientation may describe the angular position using Euler angles, Tait-Bryan angles (also known as yaw, pitch, and roll angles), and/or Quaternions. In some instances, such as on a computer-readable medium, the orientation may be represented by an orientation matrix and/or an orientation quaternion, among other representations.

In some scenarios, measurements from sensors on the base of the robotic device may indicate that the robotic device is oriented in such a way and/or has a linear and/or angular velocity that requires control of one or more of the articulated appendages in order to maintain balance of the robotic device. In these scenarios, however, it may be the case that the limbs of the robotic device are oriented and/or moving such that balance control is not required. For example, the body of the robotic device may be tilted to the left, and sensors measuring the body's orientation may thus indicate a need to move limbs to balance the robotic device; however, one or more limbs of the robotic device may be extended to the right, causing the robotic device to be balanced despite the sensors on the base of the robotic device indicating otherwise. The limbs of a robotic device may apply a torque on the body of the robotic device and may also affect the robotic device's center of mass. Thus, orientation and angular velocity measurements of one portion of the robotic device may be an inaccurate representation of the orientation and angular velocity of the combination of the robotic device's body and limbs (which may be referred to herein as the “aggregate” orientation and angular velocity).

In some implementations, the processing system may be configured to estimate the aggregate orientation and/or angular velocity of the entire robotic device based on the sensed orientation of the base of the robotic device and the measured joint angles. The processing system has stored thereon a relationship between the joint angles of the robotic device and the extent to which the joint angles of the robotic device affect the orientation and/or angular velocity of the base of the robotic device. The relationship between the joint angles of the robotic device and the motion of the base of the robotic device may be determined based on the kinematics and mass properties of the limbs of the robotic devices. In other words, the relationship may specify the effects that the joint angles have on the aggregate orientation and/or angular velocity of the robotic device. Additionally, the processing system may be configured to determine components of the orientation and/or angular velocity of the robotic device caused by internal motion and components of the orientation and/or angular velocity of the robotic device caused by external motion. Further, the processing system may differentiate components of the aggregate orientation in order to determine the robotic device's aggregate yaw rate, pitch rate, and roll rate (which may be collectively referred to as the “aggregate angular velocity”).

In some implementations, the robotic device may also include a control system that is configured to control the robotic device on the basis of a simplified model of the robotic device. The control system may be configured to receive the estimated aggregate orientation and/or angular velocity of the robotic device, and subsequently control one or more jointed limbs of the robotic device to behave in a certain manner (e.g., maintain the balance of the robotic device). For instance, the control system may determine locations at which to place the robotic device's feet and/or the force to exert by the robotic device's feet on a surface based on the aggregate orientation.

In some implementations, the robotic device may include force sensors that measure or estimate the external forces (e.g., the force applied by a leg of the robotic device against the ground) along with kinematic sensors to measure the orientation of the limbs of the robotic device. The processing system may be configured to determine the robotic device's angular momentum based on information measured by the sensors. The control system may be configured with a feedback-based state observer that receives the measured angular momentum and the aggregate angular velocity, and provides a reduced-noise estimate of the angular momentum of the robotic device. The state observer may also receive measurements and/or estimates of torques or forces acting on the robotic device and use them, among other information, as a basis to determine the reduced-noise estimate of the angular momentum of the robotic device.

The control system may be configured to actuate one or more actuators connected across components of a robotic leg. The actuators may be controlled to raise or lower the robotic leg. In some cases, a robotic leg may include actuators to control the robotic leg's motion in three dimensions. Depending on the particular implementation, the control system may be configured to use the aggregate orientation, along with other sensor measurements, as a basis to control the robot in a certain manner (e.g., stationary balancing, walking, running, galloping, etc.).

In some implementations, multiple relationships between the joint angles and their effect on the orientation and/or angular velocity of the base of the robotic device may be stored on the processing system. The processing system may select a particular relationship with which to determine the aggregate orientation and/or angular velocity based on the joint angles. For example, one relationship may be associated with a particular joint being between 0 and 90 degrees, and another relationship may be associated with the particular joint being between 91 and 180 degrees. The selected relationship may more accurately estimate the aggregate orientation of the robotic device than the other relationships.

In some implementations, the processing system may have stored thereon more than one relationship between the joint angles of the robotic device and the extent to which the joint angles of the robotic device affect the orientation and/or angular velocity of the base of the robotic device. Each relationship may correspond to one or more ranges of joint angle values (e.g., operating ranges). In some implementations, the robotic device may operate in one or more modes. A mode of operation may correspond to one or more of the joint angles being within a corresponding set of operating ranges. In these implementations, each mode of operation may correspond to a certain relationship.

The angular velocity of the robotic device may have multiple components describing the robotic device's orientation (e.g., rotational angles) along multiple planes. From the perspective of the robotic device, a rotational angle of the robotic device turned to the left or the right may be referred to herein as “yaw.” A rotational angle of the robotic device upwards or downwards may be referred to herein as “pitch.” A rotational angle of the robotic device tilted to the left or the right may be referred to herein as “roll.” Additionally, the rate of change of the yaw, pitch, and roll may be referred to herein as the “yaw rate,” the “pitch rate,” and the “roll rate,” respectively.

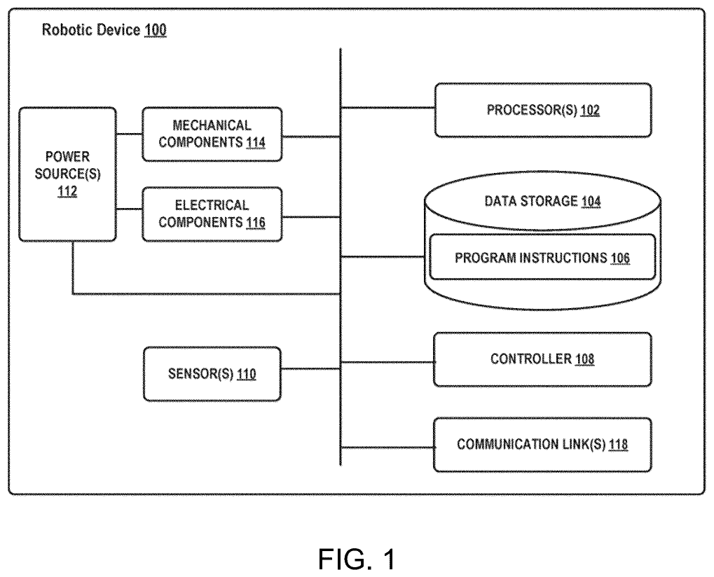

Referring now to the figures, FIG. 1 illustrates an example configuration of a robotic device (or “robot”) 100, according to an illustrative embodiment of the invention. The robotic device 100 represents an example robotic device configured to perform the operations described herein. Additionally, the robotic device 100 may be configured to operate autonomously, semi-autonomously, and/or using directions provided by user(s), and may exist in various forms, such as a humanoid robot, biped, quadruped, or other mobile robot, among other examples. Furthermore, the robotic device 100 may also be referred to as a robotic system, mobile robot, or robot, among other designations.

As shown in FIG. 1, the robotic device 100 includes processor(s) 102, data storage 104, program instructions 106, controller 108, sensor(s) 110, power source(s) 112, mechanical components 114, and electrical components 116. The robotic device 100 is shown for illustration purposes and may include more or fewer components without departing from the scope of the disclosure herein. The various components of robotic device 100 may be connected in any manner, including via electronic communication means, e.g., wired or wireless connections. Further, in some examples, components of the robotic device 100 may be positioned on multiple distinct physical entities rather on a single physical entity. Other example illustrations of robotic device 100 may exist as well.

Processor(s) 102 may operate as one or more general-purpose processor or special purpose processors (e.g., digital signal processors, application specific integrated circuits, etc.). The processor(s) 102 can be configured to execute computer-readable program instructions 106 that are stored in the data storage 104 and are executable to provide the operations of the robotic device 100 described herein. For instance, the program instructions 106 may be executable to provide operations of controller 108, where the controller 108 may be configured to cause activation and/or deactivation of the mechanical components 114 and the electrical components 116. The processor(s) 102 may operate and enable the robotic device 100 to perform various functions, including the functions described herein.

The data storage 104 may exist as various types of storage media, such as a memory. For example, the data storage 104 may include or take the form of one or more computer-readable storage media that can be read or accessed by processor(s) 102. The one or more computer-readable storage media can include volatile and/or non-volatile storage components, such as optical, magnetic, organic or other memory or disc storage, which can be integrated in whole or in part with processor(s) 102. In some implementations, the data storage 104 can be implemented using a single physical device (e.g., one optical, magnetic, organic or other memory or disc storage unit), while in other implementations, the data storage 104 can be implemented using two or more physical devices, which may communicate electronically (e.g., via wired or wireless communication). Further, in addition to the computer-readable program instructions 106, the data storage 104 may include additional data such as diagnostic data, among other possibilities.

The robotic device 100 may include at least one controller 108, which may interface with the robotic device 100. The controller 108 may serve as a link between portions of the robotic device 100, such as a link between mechanical components 114 and/or electrical components 116. In some instances, the controller 108 may serve as an interface between the robotic device 100 and another computing device. Furthermore, the controller 108 may serve as an interface between the robotic device 100 and a user(s). The controller 108 may include various components for communicating with the robotic device 100, including one or more joysticks or buttons, among other features. The controller 108 may perform other operations for the robotic device 100 as well. Other examples of controllers may exist as well.

Additionally, the robotic device 100 includes one or more sensor(s) 110 such as force sensors, proximity sensors, motion sensors, load sensors, position sensors, touch sensors, depth sensors, ultrasonic range sensors, and/or infrared sensors, among other possibilities. The sensor(s) 110 may provide sensor data to the processor(s) 102 to allow for appropriate interaction of the robotic device 100 with the environment as well as monitoring of operation of the systems of the robotic device 100. The sensor data may be used in evaluation of various factors for activation and deactivation of mechanical components 114 and electrical components 116 by controller 108 and/or a computing system of the robotic device 100.

The sensor(s) 110 may provide information indicative of the environment of the robotic device for the controller 108 and/or computing system to use to determine operations for the robotic device 100. For example, the sensor(s) 110 may capture data corresponding to the terrain of the environment or location of nearby objects, which may assist with environment recognition and navigation, etc. In an example configuration, the robotic device 100 may include a sensor system that may include a camera, RADAR, LIDAR, time-of-flight camera, global positioning system (GPS) transceiver, and/or other sensors for capturing information of the environment of the robotic device 100. The sensor(s) 110 may monitor the environment in real-time and detect obstacles, elements of the terrain, weather conditions, temperature, and/or other parameters of the environment for the robotic device 100.

Further, the robotic device 100 may include other sensor(s) 110 configured to receive information indicative of the state of the robotic device 100, including sensor(s) 110 that may monitor the state of the various components of the robotic device 100. The sensor(s) 110 may measure activity of systems of the robotic device 100 and receive information based on the operation of the various features of the robotic device 100, such the operation of extendable legs, arms, or other mechanical and/or electrical features of the robotic device 100. The sensor data provided by the sensors may enable the computing system of the robotic device 100 to determine errors in operation as well as monitor overall functioning of components of the robotic device 100.

For example, the computing system may use sensor data to determine the stability of the robotic device 100 during operations as well as measurements related to power levels, communication activities, components that require repair, among other information. As an example configuration, the robotic device 100 may include gyroscope(s), accelerometer(s), and/or other possible sensors to provide sensor data relating to the state of operation of the robotic device. Further, sensor(s) 110 may also monitor the current state of a function, such as a gait, that the robotic device 100 may currently be operating. Additionally, the sensor(s) 110 may measure a distance between a given robotic leg of a robotic device and a center of mass of the robotic device. Other example uses for the sensor(s) 110 may exist as well.

Additionally, the robotic device 100 may also include one or more power source(s) 112 configured to supply power to various components of the robotic device 100. Among possible power systems, the robotic device 100 may include a hydraulic system, electrical system, batteries, and/or other types of power systems. As an example illustration, the robotic device 100 may include one or more batteries configured to provide power to components via a wired and/or wireless connection. Within examples, components of the mechanical components 114 and electrical components 116 may each connect to a different power source or may be powered by the same power source. Components of the robotic device 100 may connect to multiple power sources as well.

Within example configurations, any type of power source may be used to power the robotic device 100, such as a gasoline and/or electric engine. Further, the power source(s) 112 may charge using various types of charging, such as wired connections to an outside power source, wireless charging, combustion, or other examples. Other configurations may also be possible. Additionally, the robotic device 100 may include a hydraulic system configured to provide power to the mechanical components 114 using fluid power. Components of the robotic device 100 may operate based on hydraulic fluid being transmitted throughout the hydraulic system to various hydraulic motors and hydraulic cylinders, for example. The hydraulic system of the robotic device 100 may transfer a large amount of power through small tubes, flexible hoses, or other links between components of the robotic device 100. Other power sources may be included within the robotic device 100.

Mechanical components 114 can represent hardware of the robotic device 100 that may enable the robotic device 100 to operate and perform physical functions. As a few examples, the robotic device 100 may include actuator(s), extendable leg(s) (“legs”), arm(s), wheel(s), one or multiple structured bodies for housing the computing system or other components, and/or other mechanical components. The mechanical components 114 may depend on the design of the robotic device 100 and may also be based on the functions and/or tasks the robotic device 100 may be configured to perform. As such, depending on the operation and functions of the robotic device 100, different mechanical components 114 may be available for the robotic device 100 to utilize. In some examples, the robotic device 100 may be configured to add and/or remove mechanical components 114, which may involve assistance from a user and/or other robotic device. For example, the robotic device 100 may be initially configured with four legs, but may be altered by a user or the robotic device 100 to remove two of the four legs to operate as a biped. Other examples of mechanical components 114 may be included.

The electrical components 116 may include various components capable of processing, transferring, providing electrical charge or electric signals, for example. Among possible examples, the electrical components 116 may include electrical wires, circuitry, and/or wireless communication transmitters and receivers to enable operations of the robotic device 100. The electrical components 116 may interwork with the mechanical components 114 to enable the robotic device 100 to perform various operations. The electrical components 116 may be configured to provide power from the power source(s) 112 to the various mechanical components 114, for example. Further, the robotic device 100 may include electric motors. Other examples of electrical components 116 may exist as well.

In some implementations, the robotic device 100 may also include communication link(s) 118 configured to send and/or receive information. The communication link(s) 118 may transmit data indicating the state of the various components of the robotic device 100. For example, information read in by sensor(s) 110 may be transmitted via the communication link(s) 118 to a separate device. Other diagnostic information indicating the integrity or health of the power source(s) 112, mechanical components 114, electrical components 116, processor(s) 102, data storage 104, and/or controller 108 may be transmitted via the communication link(s) 118 to an external communication device.

In some implementations, the robotic device 100 may receive information at the communication link(s) 118 that is processed by the processor(s) 102. The received information may indicate data that is accessible by the processor(s) 102 during execution of the program instructions 106, for example. Further, the received information may change aspects of the controller 108 that may affect the behavior of the mechanical components 114 or the electrical components 116. In some cases, the received information indicates a query requesting a particular piece of information (e.g., the operational state of one or more of the components of the robotic device 100), and the processor(s) 102 may subsequently transmit that particular piece of information back out the communication link(s) 118.

In some cases, the communication link(s) 118 include a wired connection. The robotic device 100 may include one or more ports to interface the communication link(s) 118 to an external device. The communication link(s) 118 may include, in addition to or alternatively to the wired connection, a wireless connection. Some example wireless connections may utilize a cellular connection, such as CDMA, EVDO, GSM/GPRS, or 4G telecommunication, such as WiMAX or LTE. Alternatively or in addition, the wireless connection may utilize a Wi-Fi connection to transmit data to a wireless local area network (WLAN). In some implementations, the wireless connection may also communicate over an infrared link, radio, Bluetooth, or a near-field communication (NFC) device.

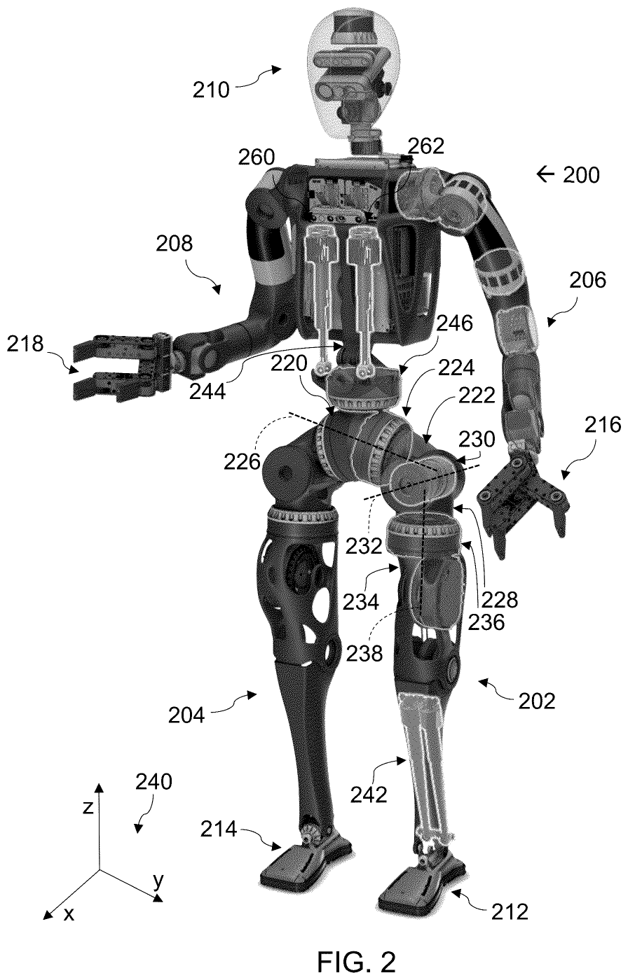

FIG. 2 illustrates an example of a humanoid robot 200, according to an illustrative embodiment of the invention. The humanoid robot 200 may correspond to the robotic device 100 shown in FIG. 1. The humanoid robot 200 serves as a possible implementation of a robotic device that may be configured to include the systems and/or carry out the methods described herein, but other implementations are also possible.

The humanoid robot 200 may include a number of articulated appendages, such as robotic legs 202, 204 and/or robotic arms 206, 208. The robot 200 may also include a robotic head 210, which may contain one or more vision sensors (e.g., cameras, infrared sensors, object sensors, range sensors, etc.). Each articulated appendage may include a number of members connected by joints that allow the articulated appendage to move through certain degrees of freedom. For example, each robotic leg 202, 204 may include a respective foot 212, 214, which may contact a surface (e.g., a ground surface). The legs 202, 204 may enable the robot 200 to travel at various speeds according to various gaits. In addition, each robotic arm 206, 208 may facilitate object manipulation, load carrying, and/or balancing of the robot 200. Each arm 206, 208 may also include one or more members connected by joints and may be configured to operate with various degrees of freedom. Each arm 206, 208 may also include a respective end effector (e.g., gripper, hand, etc.) 216, 218. The robot 200 may use end effectors 216, 218 for interacting with (e.g., gripping, turning, pulling, and/or pushing) objects. Each end effector 216, 218 may include various types of appendages or attachments, such as fingers, attached tools or grasping mechanisms.

The robot 200 may also include sensors to measure the angles of the joints of its articulated appendages. In addition, the articulated appendages may include a number of actuators that can be controlled to extend and/or retract members of the articulated appendages. In some embodiments, the angle of a joint may be determined based on the extent of protrusion and/or retraction of a given actuator. In some embodiments, the joint angles may be inferred from position data of inertial measurement units (IMUs) mounted on the members of an articulated appendage. In some embodiments, the joint angles may be measured using rotary position sensors, such as rotary encoders. In some embodiments, the joint angles may be measured using optical reflection techniques. Other joint angle measurement techniques may also be used.

The robot 200 includes a base member (e.g., a pelvis base, as shown in FIG. 2) 220. The pelvis base 220 is rotatably connected to a first hip member 222. An electric actuator 224 may be disposed between the pelvis base 220 and the first hip member 222 (e.g., in, between, connected to, and/or as part of one or both components). In some embodiments, a first portion of the electric actuator 224 may be fixed to the pelvis base 220, and a second portion of the electric actuator 224 may be fixed to the first hip member 222. The electric actuator 224 may be configured to rotate the pelvis base 220 relative to the first hip member 222 about an axis (e.g., a first hip-y axis) 226. The first hip member 222 is also connected to a first intermediate member 228. An electric actuator 230 may be disposed between the first hip member 222 and the first intermediate member 228 (e.g., in, between, connected to, and/or as part of one or both components). In some embodiments, a first portion of the electric actuator 230 may be fixed to the first hip member 222, and a second portion of the electric actuator 230 may be fixed to the first intermediate member 228. The electric actuator 230 may be configured to rotate the hip first member 222 relative to the first intermediate member 228 about an axis (e.g., a first hip-x axis) 232. The first intermediate member 228 is also connected to a first leg member 234. An electric actuator 236 may be disposed between the first intermediate member 228 and the first leg member 234 (e.g., in, between, connected to, and/or as part of one or both components). In some embodiments, a first portion of the electric actuator 236 may be fixed to the first intermediate member 228, and a second portion of the electric actuator 236 may be fixed to the first leg member 228. The electric actuator 236 may be configured to rotate the first intermediate member 228 relative to the first leg member 234 about an axis (e.g., a first hip-z axis) 238. In some embodiments, a second hip member, second intermediate member, and second leg member are connected in similar fashion to the first hip member, first intermediate member, and first leg member, using similar actuators rotating along similar additional axes and/or providing similar independently actuatable degrees of freedom (e.g., as in leg 204).

The axis 226 may be referred to as a first hip-y axis, which denotes a flexion/extension axis of the robot 200. The axis 232 may be referred to as a first hip-x axis, which denotes an abduction/adduction axis. The axis 238 may be referred to as a first hip-z axis, which denotes a pronation/supination axis. In some embodiments, the first hip-y axis intersects the first hip-x axis. In some embodiments, the first hip-y axis is displaced by a distance from the first hip-x axis. In some embodiments, this distance can be measured as a percentage of a height of the robot 200, e.g., 1-5%. In some embodiments, this distance can be made as small as possible, subject to other geometric constraints (e.g., packaging, manufacturing, aesthetic, etc.) of the robot 200. In some embodiments, the height of the robot 200 may be measured from the ground on which the robot is standing to the top of the robot's head 210 the robot is in a standing position (e.g., as shown in FIG. 2). In some embodiments, the first hip-x axis intersects the first hip-z axis. In some embodiments, the first hip-x axis is displaced by a distance from the first hip-z axis. In some embodiments, as with the displacement between the first hip-y and first hip-x axis, this distance can be measured as a percentage of the height of the robot 200, e.g., 1-5%. In some embodiments, a set of second hip axes (e.g., a second hip-x axis, a second hip-y axis, and a second hip-z axis) corresponds to similar rotation axes associated with the second leg 204.

FIG. 2 shows a set of reference axes 240 to illustrate the x, y and z directions, although, as described above, the actual axes in the robot 200 need not be mutually orthogonal or extend from the same origin. In some embodiments, rotation about the first hip-y axis 226 may cause the robot leg 202 to swing upward and backward (e.g., in a direction that would enable the robot 200 to walk forward and backward). In some embodiments, rotation about the first hip-x axis 232 may cause the robot leg 202 to swing inward (e.g., toward a center line between the legs 202, 204 of the robot 200) and outward. In some embodiments, rotation about the first hip-z axis may cause the robot leg 202 to rotate the stance of the leg (e.g., twist it to the left or to the right). In some embodiments, some or all of these rotations may be independently controllable. In some embodiments, some or all of these rotations may collectively enable the robot 200 to reproduce a wide range of motion in three dimensions (e.g., similar to or greater than that achievable by a human being). In some embodiments, the leg member 234 is an upper leg member, which may in turn be connected to a lower leg member 242 at a knee joint. In some embodiments, the lower leg member 242 is connected to the foot 212 at an ankle joint. In some embodiments, the pelvis base 220 is rotatably connected and/or configured to be rotatably connected to a back member 244 of the robot 200, e.g., via a torso actuator 246. In some embodiments, the first hip axis 226 may be oriented at a cant angle relative to a horizontal axis of the pelvis base 220 (corresponding to the actuator 224 being oriented at a cant angle relative to a vertical axis of the pelvis base 220) by a certain amount greater than 0 degrees (e.g., 5 degrees, 10 degrees, 20 degrees, or another extent). In some embodiments, the cant angle can provide additional range of motion for adduction compared with a non-canted morphology. In some embodiments, the presence of the torso actuator 246 above the pelvis base 220 preserves significant space in the pelvis, torso, and/or middle-body region of the robot 200. In some embodiments, two coupled linear screw actuators 260, 262, which may function as coupled back-x and back-y actuators, preserve significant space in the pelvis, torso, and/or middle body region.

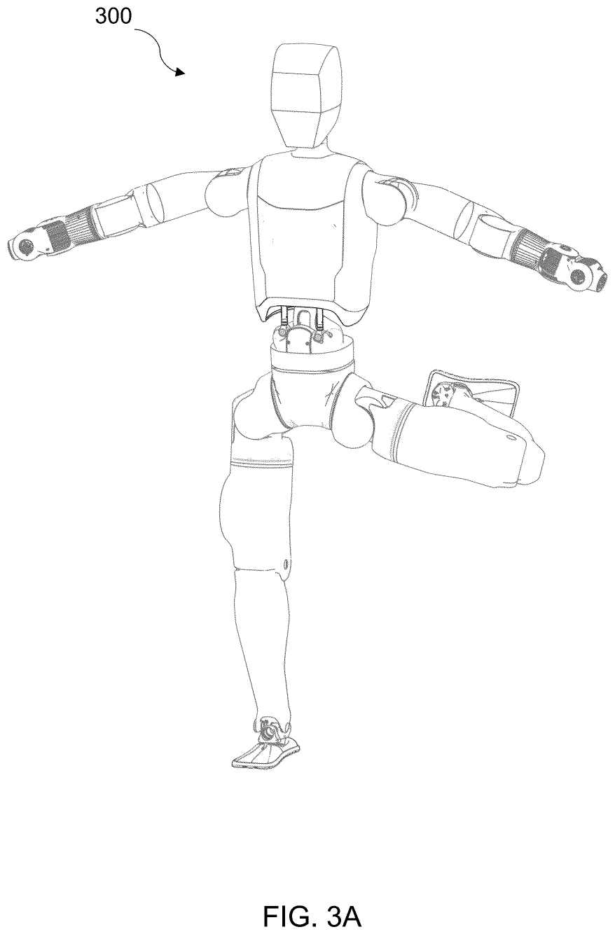

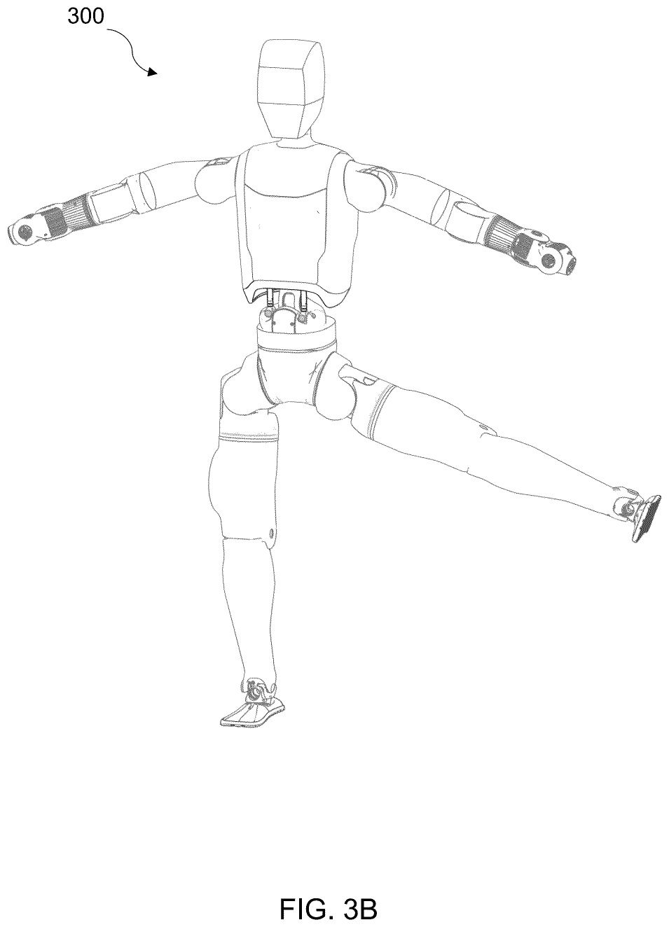

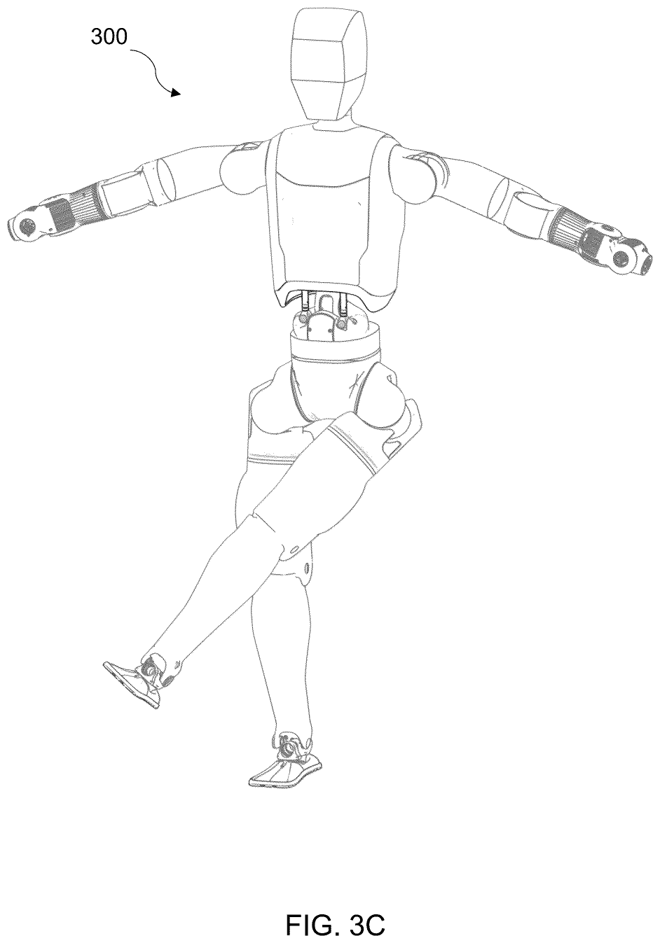

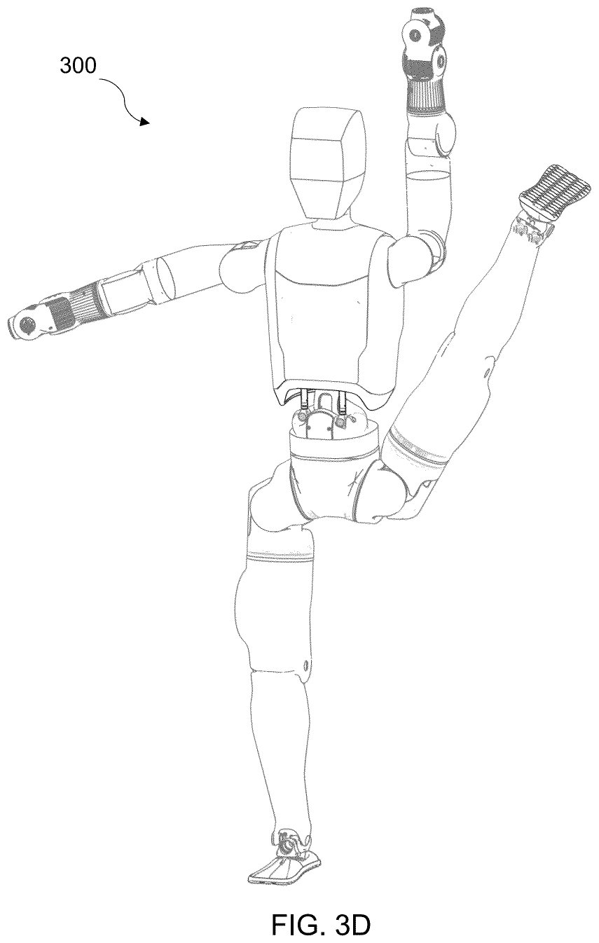

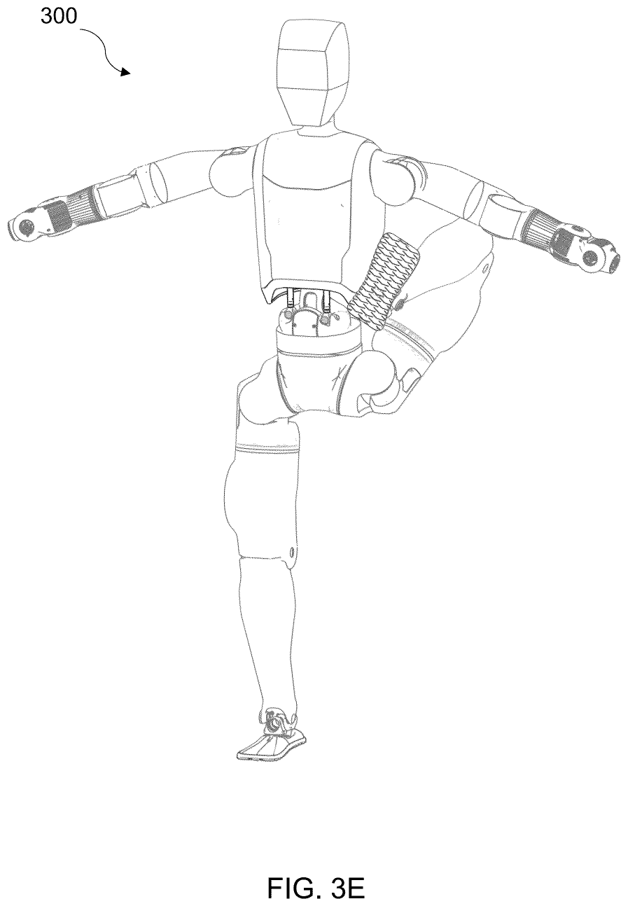

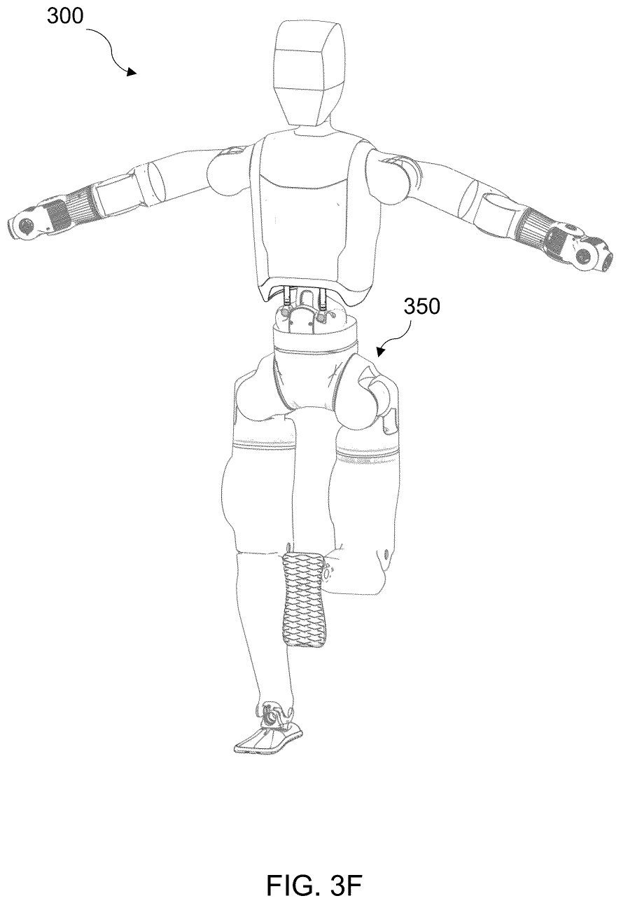

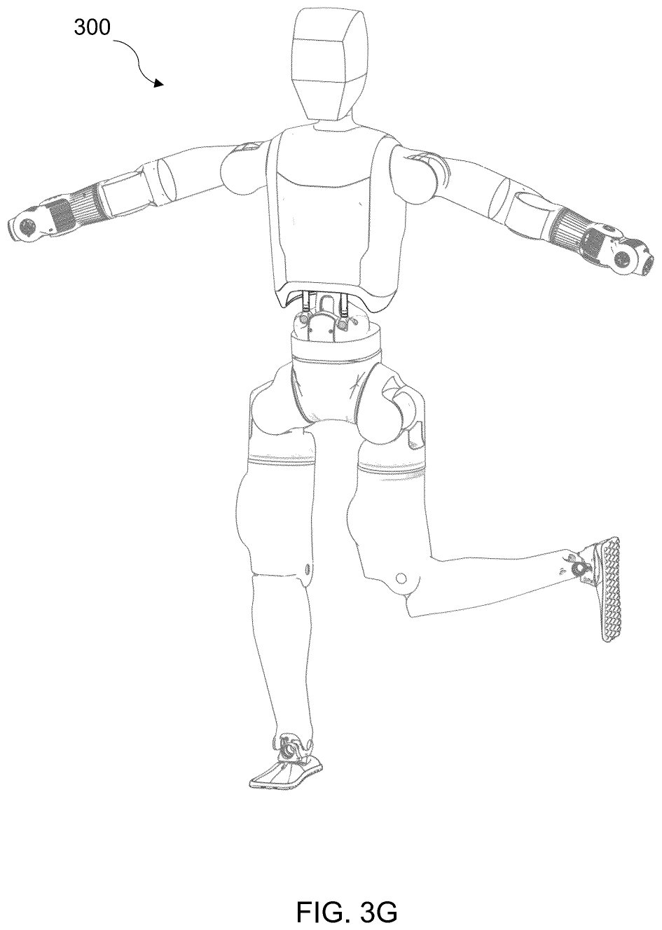

As described above, the robot 200 has a hip joint order that may be referred to as “Y-X-Z” (although a Y-Z-X configuration is also within the spirit and scope of the invention). Numerous advantages can be associated with such a configuration. First, a significant range of motion is made possible with this configuration. In particular, rotation of the legs about the hip-y axes and/or the hip-z axes may be continuous (e.g., 360 degrees and/or limitless). In addition, rotation of the legs about the hip-x axes may be large, e.g., 30-60 degrees for adduction and/or 60-200 degrees for abduction as measured relative to an upright posture or “zero pose” of the robot. In some embodiments, a greater range of motion can also be achieved by placing one or more distal actuators in regions where their swept volume does not interfere with other actuators. Second, because the actuators can be located within a frontal plane, the structures connecting the actuators can be much stronger than when the actuators are located in a front-back configuration (in each other's silhouette when viewed from the front) where such structures would need to narrow down to smaller regions. When cantilevered, the cantilever can be much more manageable (e.g., more manufacturable (cheaper, more production options, etc.), stronger, stiffer, lighter, more range of motion, more balanced forces, easier to use an identical part on both sides of the robot, etc.) than other joint orders, and double supports (e.g., yokes) are also achievable for the middle (e.g., hip-X) actuator (e.g., as visible in FIG. 3F). Third, because the Y-X-Z configuration shown in FIG. 2 enables a large range of motion for the robot 200, the robot 200 has a greater workspace, more flexibility (e.g., reach), and a greater ability to perform additional gaits and behaviors than if another configuration was used. Fourth, the configuration shown also results in a more slender robot 200, which has aesthetic benefits, as well as the ability to fit into more confined spaces. Fifth, the configuration shown in FIG. 2 also results in stiffer, stronger structures, which makes the robot 200 easier to control, more dynamic, and/or lighter. In some embodiments, some or all of these advantages can also be associated with a Y-Z-X joint order configuration. In some embodiments, a Y-Z-X configuration can include similar benefits (e.g., in compact packaging) and additional benefits, including a larger hip-X range of motion and/or greater design freedom for the hip-X actuator (e.g., the actuator can also have at least a 1:1 aspect ratio of diameter to length, or “pancake” configuration).

In some embodiments, the selection of actuators with certain features can help provide one or more of the above benefits. In some embodiments, using a hip-y actuator 224 with a “pancake” aspect ratio enables high torque within a low hip width. In some embodiments, the actuator 224 relies primarily on a diameter dimension (rather than a length dimension) to achieve high torque, which enables the actuator 224 to fit within the geometry of the robot 200 while still outputting high torque. In some embodiments, the aspect ratio (diameter/length) of the hip-y actuator is 1:1 or greater, e.g., 1.25:1, 1.5:1, 2:1 or 3:1. In some embodiments, the Y-X-Z (or Y-Z-X) joint order configuration eliminates the need for actuator connectors to “reach around” other components (e.g., rigid members and/or other actuators), as in numerous known humanoid robots, thus enabling both aesthetic appeal and greater stiffness. In some embodiments, a reduced hip width lowers torque requirements while walking, allows the robot to fit into tighter spaces, and/or provides a streamlined form factor that reduces the likelihood of the robot inadvertently interacting with objects in its environment during movement. In some embodiments, using one or more planetary gearboxes (e.g., one single stage planetary gearbox in each of the actuators 224, 236) can lower the cost of construction, enable a higher efficiency, enable the use of current sensing (as opposed to load sensing), lower the actuator's reflected inertia, and/or enable a higher “pancake” aspect ratio. In some embodiments, using bearings in the actuator 224 that resist large moments enables a stronger robot with the ability to handle larger payloads.

FIGS. 3A-3G illustrate example views of a humanoid robot in different poses, according to an illustrative embodiment of the invention. For comparison, in FIG. 2, the robot 200 is in a “ground state” configuration, in which its legs 202, 204 are parallel and oriented straight downward and its feet 212, 214 are parallel. In FIG. 3A, the left hip abduction/adduction (e.g., hip-x) actuator of the robot 300 is rotated to about 75 degrees from the ground state configuration, and the left knee is folded by about 90 degrees. In FIG. 3B, the left hip abduction/adduction (e.g., hip-x) actuator of the robot 300 is rotated to the same position as in FIG. 3A, with the left knee extended such that the left lower leg is inline with the left upper leg. In FIG. 3C, the left hip abduction/adduction (e.g., hip-x) actuator of the robot 300 is rotated to about-40 degrees from the ground state configuration (i.e., about 40 degrees in the opposite direction as in FIGS. 3A-3B), and the left hip flexion/extension (e.g., hip-y) actuator is rotated to about 30 degrees. In FIG. 3D, the left hip abduction/adduction (e.g., hip-x) actuator of the robot 300 is rotated to a similar extent (e.g., about-40 degrees) as shown in FIG. 3C, and the left hip flexion/extension (e.g., hip-y) actuator is rotated to about 210 degrees (e.g., in substantially the opposite direction as shown in FIG. 3C). In FIG. 3E, the configuration is substantially the same as in FIG. 3D, except the lower leg member is rotated downward (e.g., by the knee actuator in the leg). In FIG. 3F, the configuration is substantially the same as in FIG. 3E, except the left pronation/supination (e.g., hip-z actuator) of the robot 300 is rotated to about 180 degrees, and the hip-y actuator is in the ground state position. In FIG. 3F, the “double yoke” 350 described above is visible. In FIG. 3G, the configuration is the same as in FIG. 3F, except the left pronation/supination (e.g., hip-z) actuator of the robot 300 is rotated to about 90 degrees.

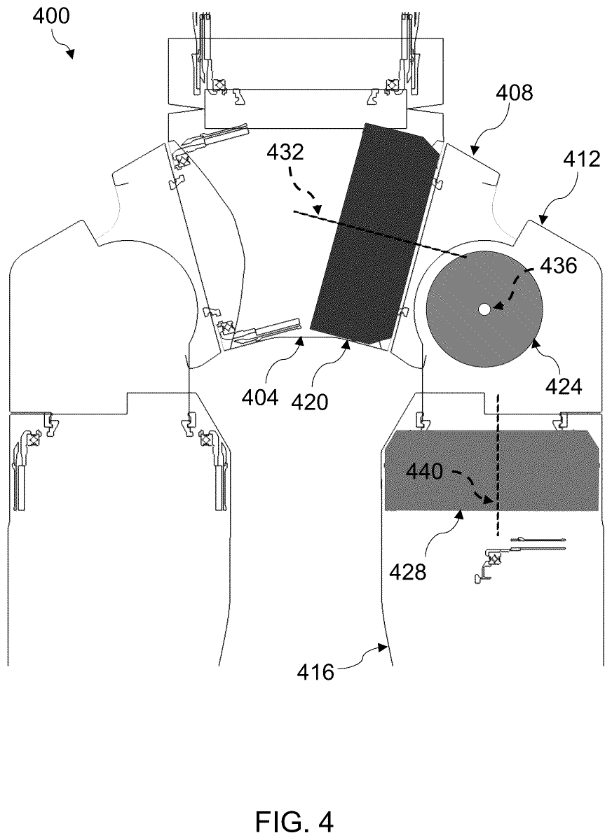

FIG. 4 illustrates an example cross-sectional view of a middle-body region of a humanoid robot 400, according to an illustrative embodiment of the invention. The robot 400 includes similar members and actuators as depicted above (e.g., for robot 200 shown in FIG. 2), including a base member (e.g., a pelvis base 404, as shown in FIG. 4), a first hip member 408, a first intermediate member 412, a first leg member 416, a first actuator 420 disposed between the pelvis base 404 and the first hip member 408, a second actuator 424 disposed between the first hip member 408 and the first intermediate member 412, and a third actuator 428 disposed between the first intermediate member 412 and the first leg member 416. The first actuator 420 rotates about a first axis 432 (e.g., a first hip-y axis). In some embodiments, the rotation range of the first actuator 420 is between 45 and 150 degrees (e.g., between 90 and 135 degrees). The second actuator 424 rotates about a second axis 436 (e.g., a first hip-x axis). The third actuator 428 rotates about a third axis 440 (e.g., a first hip-z axis). Similar members, actuators and axes may be used for the other leg on the other side of the robot 400.

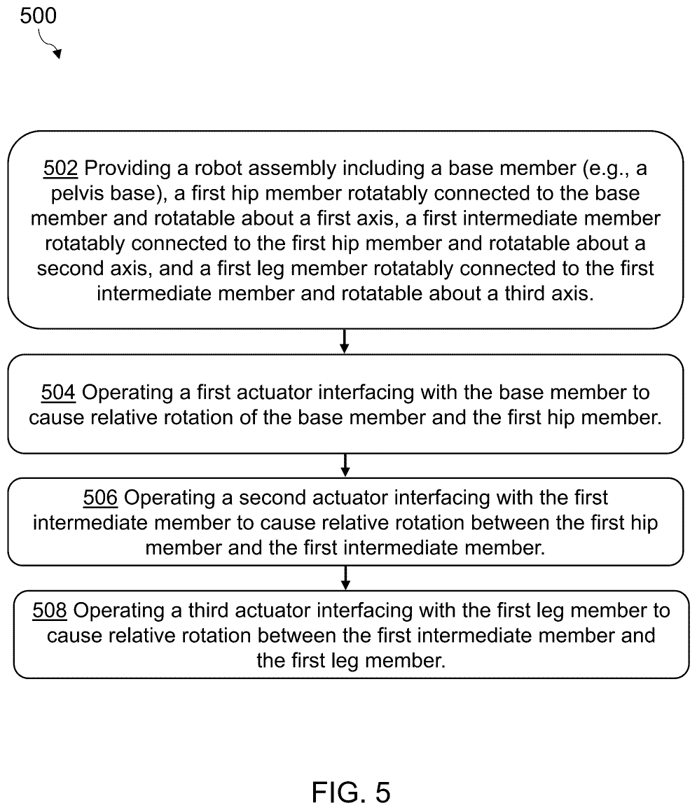

FIG. 5 illustrates a flowchart of an exemplary computer-implemented method, according to an illustrative embodiment of the invention. At act 502, a robot assembly (e.g., a humanoid robot assembly) is provided that includes a base member (e.g., a pelvis base), a first hip member rotatably connected to the first side of the base member and rotatable about a first hip axis, a first intermediate member rotatably connected to the first hip member and rotatable about a second hip axis, and a first leg member rotatably connected to the first intermediate member and rotatable about a third hip axis. At act 504, a first actuator interfacing with the base member is operated to cause relative rotation of the base member and the first hip member. At act 506, a second actuator interfacing with the first intermediate member is operated to cause relative rotation between the first hip member and the first intermediate member. At act 508, a third actuator interfacing with the first leg member is operated to cause relative rotation between the first intermediate member and the first leg member. In some embodiments, the elements recited above (e.g., the various members and actuators) include one or more additional features as described above in FIGS. 1-4.

A number of implementations have been described. Nevertheless, it will be understood that various modifications may be made without departing from the spirit and scope of the disclosure.

1. A robot assembly comprising:
a pelvis base;
a first hip member rotatably connected to the pelvis base, the first hip member connected to a first electric actuator configured to rotate the first hip member about a first hip axis relative to the pelvis base, wherein the first electric actuator has a diameter to length ratio of greater than 1.25;
a first intermediate member rotatably connected to the first hip member, the first intermediate member connected to a second electric actuator configured to rotate the first intermediate member about a second hip axis relative to the first hip member, wherein the second electric actuator has a diameter to length ratio of less than 0.80; and
a first leg member rotatably connected to the first intermediate member, the first leg member connected to a third electric actuator configured to rotate the first leg member about a third hip axis relative to the first intermediate member, wherein the third electric actuator has a diameter to length ratio of greater than 1.25.

2. The robot assembly of claim 1, wherein the first hip axis is a flexion/extension axis, the second hip axis is an abduction/adduction axis, and the third hip axis is a pronation/supination axis.

3. The robot assembly of claim 1, wherein the first hip axis is a flexion/extension axis, the second hip axis is a pronation/supination axis, and the third hip axis is an abduction/adduction axis.

4. The robot assembly of claim 1, further comprising:
a second hip member rotatably connected to the pelvis base, the second hip member connected to a fourth electric actuator configured to rotate the second hip member about a fourth hip axis relative to the pelvis base, wherein the fourth electric actuator has a diameter to length ratio of greater than 1.25;
a second intermediate member rotatably connected to the second hip member, the second intermediate member connected to a fifth electric actuator configured to rotate the second intermediate member about a fifth hip axis relative to the pelvis base, wherein the fifth electric actuator has a diameter to length ratio of less than 0.80; and
a second leg member rotatably connected to the second intermediate member, the second leg member connected to a sixth electric actuator configured to rotate the second leg member about a sixth hip axis relative to the first intermediate member, wherein the sixth electric actuator has a diameter to length ratio of greater than 1.25.

5. The robot assembly of claim 4, wherein the fourth hip axis is a second flexion/extension axis, the fifth hip axis is a second abduction/adduction axis, and the third hip axis is a second pronation/supination axis.

6. The robot assembly of claim 4, wherein the fourth hip axis is a second flexion/extension axis, the fifth hip axis is a second pronation/supination axis, and the third hip axis is a second abduction/adduction axis.

7. The robot assembly of claim 1, wherein the first hip axis intersects, or is displaced by not more than a threshold distance from, the second hip axis, wherein the threshold distance is 5% of a height of a robot that includes the robot assembly.

8. The robot assembly of claim 1, wherein the second hip axis intersects, or is displaced by not more than a threshold distance from, the third hip axis, wherein the threshold distance is 5% of a height of a robot that includes the robot assembly.

9. The robot assembly of claim 1, wherein the pelvis base is rotatably connected to a back member.

10. The robot assembly of claim 1, wherein the first hip member is continuously rotatable about the first hip axis.

11. The robot assembly of claim 1, wherein the first leg member is continuously rotatable about the third hip axis.

12. The robot assembly of claim 4, wherein the second hip member is continuously rotatable about the fourth hip axis.

13. The robot assembly of claim 4, wherein the second leg member is continuously rotatable about the sixth hip axis.

14. The robot assembly of claim 1, wherein the first electric actuator has a diameter to length ratio of at least 2:1.

15. The robot assembly of claim 1, wherein the second electric actuator has a diameter to length ratio of at most 0.5.

16. The robot assembly of claim 1, wherein the third electric actuator has a diameter to length ratio of at least 2:1.

17. The robot assembly of claim 1, wherein the first hip member is canted at least 5 degrees relative to a vertical axis of the pelvis base.

18. The robot assembly of claim 1, further comprising a first back member positioned above the pelvis base, the first back member connected to a first back actuator positioned above the pelvis base.

19. A method of operating a robot assembly, comprising:
providing a robot assembly including a pelvis base, a first hip member rotatably connected to the pelvis base and rotatable about a first axis, a first intermediate member rotatably connected to the first hip member and rotatable about a second axis, and a first leg member rotatably connected to the first intermediate member and rotatable about a third axis;
operating a first actuator interfacing with the pelvis base to cause relative rotation of the pelvis base and the first hip member;
operating a second actuator interfacing with the first intermediate member to cause relative rotation of the first hip member and the first intermediate member; and
operating a third actuator interfacing with the first leg member to cause relative rotation of the first intermediate member and the first leg member;
wherein the first actuator has a diameter to length ratio of greater than 1.25, the second actuator has a diameter to length ratio of less than 0.80, and the third actuator has a diameter to length ratio of greater than 1.25.

20. The method of claim 19, wherein the first axis is a flexion/extension axis, the second axis is an abduction/adduction axis, and the third axis is a pronation/supination axis.
